(19) United States
(12) Patent Application Publication
(10) Pub. No.: US 2005/0213007 A1
(43) Pub. Date: Sep. 29, 2005

(54) Pixel array for an LCD (Liquid Crystal Display) panel

(75) Inventor: Ming-Chou Wu, Nan Tou Hsien (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 10/937,267

(22) Filed: Sep. 10, 2004

(30) Foreign Application Priority Data
Mar. 23, 2004 (TW) 93107824

(51) Int. Cl. G02F 1/1337

(52) U.S. Cl. 349/129

(57) ABSTRACT

A pixel array for an LCD panel includes a plurality of pixel units scattered in an array manner. Each pixel unit includes a common electrode, a liquid crystal layer and a pixel electrode, wherein a plurality of pixel patterns are fabricated on the common electrode and the pixel electrode, and wherein the pixel patterns of adjacent two of the pixel electrodes are symmetric.

### FIELD OF THE INVENTION

The present invention relates to a pixel array for a TFT-LCD panel, more specifically to a pixel array that is arranged in multi-domain vertical alignment and that has an ultra high aperture rate (UHA).

### BACKGROUND OF THE INVENTION

Advance in manufacture of TFT technology consequently brings improvement to an LCD panel such that the latter can be constructed in compact size with low power consumption and lower radiation. The TFT technology is employed in manufacture of personal computers, personal digital assistances (PDA), digital watches, notebook computers, digital cameras, mobile phones, and many other consumer electronics. The manufacturers worldwide have devoted themselves to further research and thus improve the materials, processes and equipments. The qualities of the LCD panel are accordingly and largely promoted while the cost goes down day-by-day, which, in turn, causes a wide use of the LCD panels. The main research relating to the LCD panel resides in how to shorten the response time of the screen and how to increase the viewing angles of the user.

In order to achieve the aforesaid requirements, the pixel array in an LCD panel presently available is arranged in multi-domain vertical alignment. During the construction operation, a plurality of protrusions or slits are fabricated on the pixel electrode such that the liquid crystal molecules are slightly inclined relative to a vertical line when no voltage is applied thereto. Under this condition, when a voltage is passed through the pixel electrodes, the orientation of the liquid crystal molecules is changed swiftly from their initial position to a pre-targeted direction, thereby greatly shortening a response time of the panel screen meanwhile the transmittance rate and the image ratio are increased to as to provide a wide range view on the screen. FIGS. 1 and 2 illustrate top and sectional views of a prior art pixel array to include a plurality of pixel electrodes 1. A thin film transistor 10 is disposed under the right corner of each of the pixel electrodes 1 for controlling the voltage of the respective pixel electrode 1. A gate line 11 transversely passes under the pixel electrodes 1 for transmitting scanning signals between the thin film transistors 10 in the pixel array. The gap “D” disposed between adjacent two of the pixel electrodes 11 is used for fixing a data line 22. When the thin film transistors 10 are switched on, voltage can be passed to the pixel electrodes 1 via the data line 22 so as to drive the liquid crystal layer 23 for displaying an image on the screen. An auxiliary capacitor 12 transversely passes through central portions of the pixel electrodes 1 for storing voltage so that when the thin film transistors 10 are switched off, the pixel electrodes 1 can maintain at a predetermined current level. As disclosed in the above-mentioned manner, a protrusion 13 can be formed on one of the color filters 24 and a slit 14 can be formed in one of the pixel electrodes 1 such that the liquid crystal molecules 231 incline relative to the respective protrusion 13 and the respective slits 14 in order to provide multi-domain effect.

FIG. 2 is a sectional view taken along lines a-a′ in FIG. 1, in which two adjacent pixel electrodes 1 are fabricated successively on a lower glass substrate 20 and a dielectric layer 21, and are spaced apart by a gap “D” of 18 microns. Under the gap “D” and at a lower surface of the dielectric layer 21, a channel with 4 microns in width is provided to receive the data line 22 therein. The liquid crystal layer 23, the color filters 24 and an upper glass substrate 25 are respectively disposed on the pixel electrodes 1. As best shown in FIG. 1, the protrusion 13 is formed on the left side color filter 24 while a slit 14 is formed on the right pixel electrode 1 so as to permit inclination of the liquid crystal molecules 231 with respect to outer surfaces of the pixel electrodes 1.

Note that during the manufacture of the LCD panel, the pixel electrodes in the pixel array are arranged to be located densely in order to increase the high aperture rate. When thus arranged, the gap between adjacent two of the pixel electrodes becomes too small that the liquid crystal molecules at adjoining edges of the adjacent pixel electrodes are disposed in an irregular manner, which, in turn, causes darkened lines on the screen.

Referring to FIG. 3, only a gap “d” of 4 microns in width (about the width of data line 22) is preserved between the two adjacent pixel electrodes 1 in order to increase the high aperture rate of the LCD panel. The orientation of the liquid crystal molecules in the liquid crystal layer 23 are forced to extend in non-regular condition, as best shown in FIG. 4, due to the gap “d” limitation. The situation is aggravated because the voltage difference between two data signals applied respectively onto the adjacent two pixel electrodes will cause a transversely extending electrical field, which, in turn, can cause dark lines on the screen.

### SUMMARY OF THE INVENTION

The object of the present invention is to provide an LCD panel having a pixel array which is provided in such a manner to prevent forming of dark lines on the screen of the LCD panel.

According to one aspect of the present invention, an LCD panel is provided to include a lower glass substrate, an upper glass substrate, and a liquid crystal layer disposed between the lower and upper glass substrates. The LCD panel further includes: a common electrode mounted on a lower surface of the upper glass substrate; and a plurality of pixel electrodes fabricated on an outer surface of the lower glass substrate in an array manner, wherein each of the pixel electrodes has a protrusion and a slit cooperatively defining a respective pixel pattern, and wherein the pixel patterns of adjacent two of the pixel electrodes are disposed symmetrically along a left-and-right line.

In a second aspect of the present invention, a pixel array for an LCD panel is proposed to include a plurality of pixel units scattered in an array manner. Each of the pixel units includes a common electrode, a liquid crystal layer and a pixel electrode, wherein a plurality of pixel patterns are fabricated on the common electrode and the pixel electrode, and wherein the pixel patterns of adjacent two of the pixel electrodes are disposed symmetrically along a left-and-right line.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates adjacent two pixel electrodes of a pixel array used in a prior art LCD (Liquid Crystal Display) panel;

FIG. 2 shows fragmentary sectional view, illustrating how liquid crystal molecules are scattered in the pixel electrodes of the pixel array used in the prior art LCD (Liquid Crystal Display) panel;

FIG. 3 shows fragmentary sectional view, illustrating how the liquid crystal molecules are scattered densely in the adjacent pixel. electrodes of the pixel array used in the prior art LCD (Liquid Crystal Display) panel;

FIG. 4 illustrates irregular orientation of the liquid crystal molecules in the pixel electrodes of the pixel array used in the prior art LCD (Liquid Crystal Display) panel due too close location between adjacent two of the pixel electrodes;

FIG. 5 illustrates two adjacent pixel electrodes of the pixel array used in an LCD (Liquid Crystal Display) panel according to the present invention;

FIG. 6 shows fragmentary sectional view, illustrating how liquid crystal molecules are scattered in the pixel electrodes of the pixel array used in the LCD (Liquid Crystal Display) panel according to the present invention; and

FIG. 7 shows the orientation the liquid crystal molecules in the pixel electrodes of the pixel array used in the LCD (Liquid Crystal Display) panel according to the present invention.

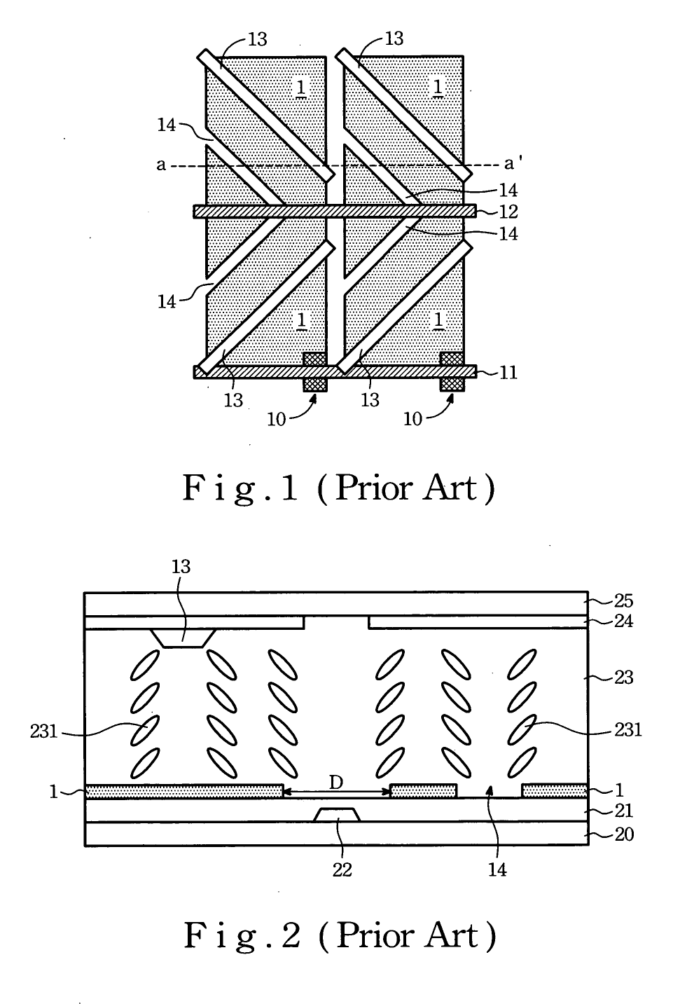

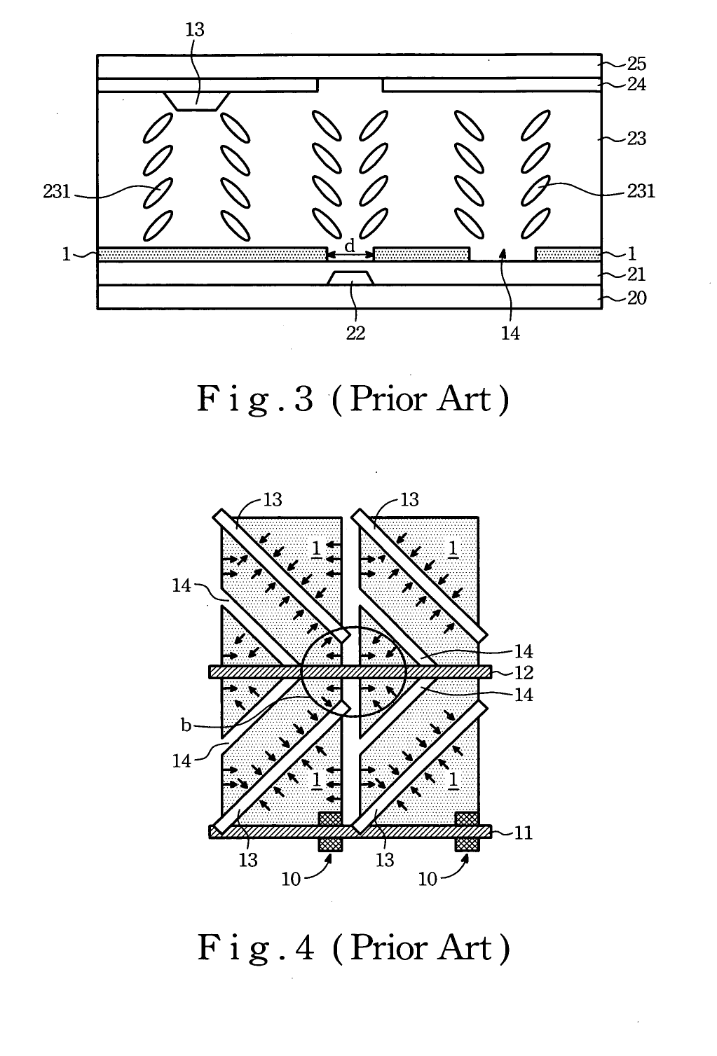

### DETAILED DESCRIPTION OF THE PREFERRED EMBODIMENT

A pixel array fabricated in an LCD panel of the present invention is proposed to include a plurality of pixel units. Each of the pixel units comprises a respective pixel pattern which is constituted by a protrusion and a slit that are formed respectively on outer surfaces of an upper electrode and a lower electrode (common electrode, pixel electrode) to provide multi-domain effects. When the pixel patterns of adjacent two of the pixel units in the pixel array are disposed densely relative to each other, the pixel patterns are disposed symmetrically along a vertical line. The detailed description of the present invention is as follows.

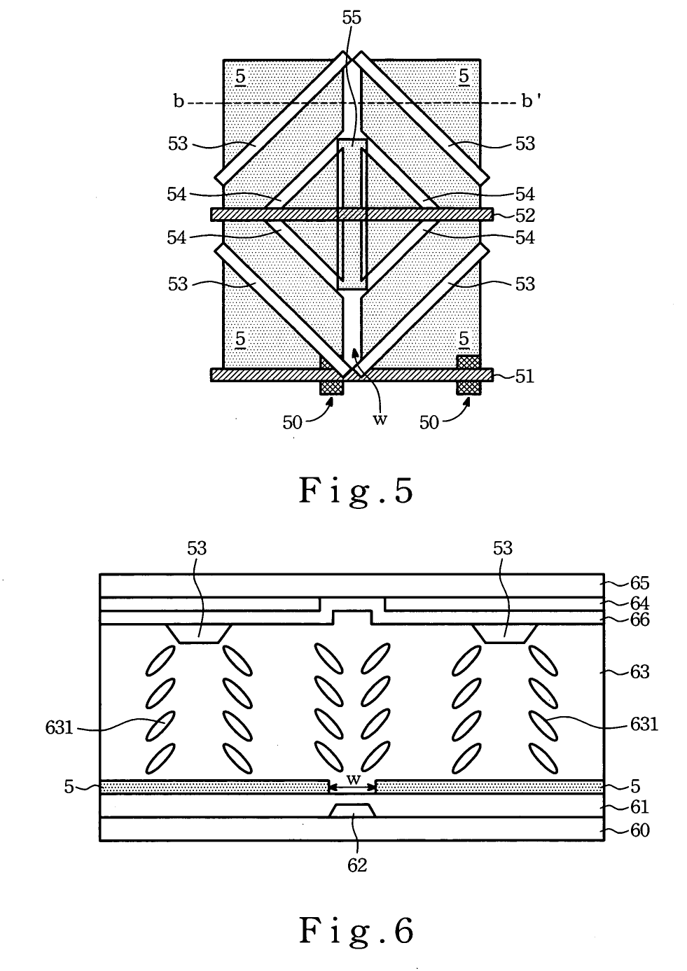

FIGS. 5 and 6 respectively show top and fragmentary view of the pixel array fabricated in the LCD panel according to the present invention. The pixel array includes a plurality of pixel units that are scattered over the panel in an array manner. Each of the pixel units includes from top to bottom, a common electrode 66, a liquid crystal layer 63, and a pixel electrode 5. In FIG. 5, two adjacent pixel electrodes 5 are shown.

In order to provide the multi-domain effects, the protrusion 53 or the slit 54 is formed on the pixel electrode 5 and the common electrode 66 of each pixel unit. Note that the liquid crystals 631 of the pixel patterns located at adjoining edges of two adjacent pixel units are disposed symmetrically along the vertical line.

The protrusion and slit which are used to provide the multi-domain effect and which cooperatively define a respective pixel pattern can be fabricated on the pixel electrode 5 and the common electrode 66 of a respective pixel unit. In this invention, the pixel patterns on the pixel electrodes 5 or the common electrodes 66 are scattered symmetrically alone the vertical line.

For better understanding, the pixel electrode 5 of each pixel unit is taken as an example. In practice, the protrusion or the recession, which defines the respective pixel pattern, can also be formed on the common electrode to achieve multi-domain effect. Thus, the pixel patterns fabricated on the common electrode 66 are disposed symmetrically along the vertical line.

Referring to FIG. 5, a thin film transistor 50 is disposed under the right corner of each of the pixel electrode 5 to provide voltage for transferring the data signal to the pixel electrode 5. A gate line 51 transversely passes under the pixel electrodes 5 for transmitting scanning signals to switch on or switch off the TFTs 10 in the same row. The gap “W” disposed between two adjacent pixel electrodes 5 is used for fixing a data line (not shown). When the thin film transistors 50 are switched on, voltage can be passed to the pixel electrodes 5 via the data line 62 so as to drive the liquid crystal layer 63 for displaying an image on the screen. An auxiliary capacitor 52 transversely passes through central portions of the pixel electrodes 5 for storing voltage so that when the thin film transistors 50 are switched off, the pixel electrodes 5 can maintain at a predetermined current level.

Referring to FIG. 5, at an elevation above the gap “W” defined between two adjacent common electrodes 5, a rod-shaped projection 55 is disposed to correspond with the common electrode 66 in such a manner that the latter extends along the entire length of the gap “W”. Two longitudinal slits 54 are formed on each of the pixel electrodes 5. Two longitudinal projections 53 are formed at the lower side of the color filter 64 in such a manner that the adjacent slits 54 are disposed at two opposite sides of the projection 55 and that the slits 54 extend toward and intersect at a middle portion of the pixel electrodes 5. As illustrated, each of the longitudinal slits 54 generally forms an angle of 45° with respective to an auxiliary capacitor 52 that passes the central portions of the pixel electrodes 5. Under such condition, the two longitudinal slits 54 of each of the pixel electrodes 5 form two 45° angles with respect to the capacitors 52 while the longitudinal projection 53 is disposed below the common electrode 66, and extends parallel with the respective one of the slits 54. In other word, each of the longitudinal projections 53 is disposed outside of a respective longitudinal slit 54, extends through the respective pixel electrode 5, intersects with each other at the gate line 51.

Because the pixel patterns on the adjacent two pixel electrodes 5 are symmetrically scattered along the vertical line as shown in FIG. 5, the slits 54 on the pixel electrodes 5 cooperatively define an inner square configuration, which accordingly surrounds the rod-shaped projection 55. Under this condition, the projections 53 extend respectively parallel with the slits 54, define an outer square configuration surrounding the inner square configuration.

FIG. 6 is a sectional view taken along lines b-b′ in FIG. 5, wherein the adjacent two of the pixel electrodes 5 are fabricated successively on the lower glass substrate 60 and the dielectric layer 61 at left and right sides thereof. The gap “W” is defined between the adjacent pixel electrodes 5. In order to increase the aperture rate in the LCD panel, the adjacent pixel electrode 5 are arranged to be located densely so as to narrow the gap “W” about 1 to 10 microns. A channel of 4 microns in width is provided below the lower surface of the dielectric layer 61 and under the gap “W” for fixing the data line 62. The liquid crystal layer 63, the common electrode 66 and the upper glass substrate 65 are mounted successively on the pixel electrodes 5. Since the projections 53 and the slits 54 are scattered symmetrically along the vertical line, the liquid crystal molecules 631 of the liquid crystal layer 63 are inclined with respect to the outer surfaces of the pixel electrodes 5.

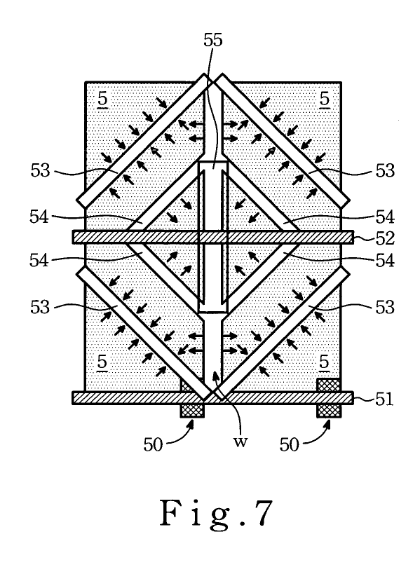

The gap “W” is reduced to 1-16 microns in contrast to the prior 18 microns and since the projections 53 and the slits 54 are symmetrically disposed along the vertical line, the liquid crystal molecules in the liquid crystal layer are oriented in the proper manner. FIG. 7 illustrates the orientation of the liquid crystal molecules, which is formed by disposing the rod-shaped projection 55 along the gap “W” and which is achieved due to symmetrical arranged of the pixel patterns of the left and right pixel electrodes. This eliminates the prior art occurrence of the irregular orientation of the liquid crystal molecules. The occurrence of dark lines on the screen panel can be avoided.

An important aspect to note that in order to achieve the same multi-domain effect shown in FIG. 7, the slits 54 formed in the common electrodes as shown in FIG. 5 can be constructed in projection configuration without altering the orientation the liquid crystal molecules.

As is understood by a person skilled in the art, the foregoing preferred embodiment of the present invention is an illustration of the present invention rather than limiting thereon. It is intended to cover various modifications and similar arrangements included within the spirit and scope of the appended claims, the scope of which should be accorded the broadest interpretation so as to encompass all such modifications and similar structure.

1. A pixel array of an LCD panel, comprising:
a plurality of pixel units having multi-domain patterns respectively, wherein the multi-domain patterns of adjacent pixel units are symmetric.

2. The pixel array according to claim 1, wherein each of the pixel units includes an upper electrode and a lower electrode, said multi-domain patterns being fabricated on an outer surface of said lower electrode.

3. The pixel array according to claim 2, wherein said multi-domain patterns include a protrusion and a slit fabricated on the outer surface of said lower electrode.

4. The pixel array according to claim 1, wherein each of the pixel units includes an upper electrode and a lower electrode, said multi-domain patterns being fabricated respectively on outer surfaces of said upper and lower electrodes.

5. The pixel array according to claim 4, wherein said multi-domain patterns include a protrusion and a slit respectively fabricated on said outer surfaces of said upper and lower electrodes.

6. The pixel array according to claim 1, wherein a gap of 1 to 16 mm is defined between adjacent pixel units.

7. An LCD panel including a lower glass substrate, an upper glass substrate, and a liquid crystal layer disposed between the lower and upper glass substrates, the LCD panel further comprising:
a common electrode mounted on a lower surface of the upper glass substrate; and
a plurality of pixel electrodes fabricated on an outer surface of the lower glass substrate in an array manner, wherein each of said pixel electrodes having a protrusion and a slit cooperatively defining a respective pixel pattern, and wherein the pixel patterns of adjacent pixel electrodes are symmetric.

8. The LCD panel according to claim 7, wherein the adjacent pixel electrodes are spaced by a gap of 1 to 16 mm.

9. A pixel array for an LCD panel including a plurality of pixel units scattered in an array manner, each of the pixel units including a common electrode, a pixel electrode and a liquid crystal layer sandwiched between the common and pixel electrodes, the pixel array comprising:
a plurality of pixel patterns fabricated on the common electrode and the pixel electrode, wherein the pixel patterns of adjacent two of the pixel electrodes are symmetric.

10. The pixel array according to claim 9, wherein each of said pixel patterns includes a protrusion and a slit fabricated on an outer surface of the pixel electrode.

11. The pixel array according to claim 10, wherein said protrusion and said slit of the adjacent two of the pixel patterns are symmetric to one another.

12. The pixel array according to claim 9, wherein each of said pixel patterns includes a protrusion and a slit fabricated on an outer surface of the common electrode.

13. The pixel array according to claim 12, wherein said protrusion and said slit of the adjacent two of the pixel patterns are symmetric to one another.

14. The pixel array according to claim 9, wherein adjacent two the pixel units are spaced by a gap of 1 to 16 mm.
